(19) United States
(12) Patent Application Publication
(10) Pub. No.: US 2026/0233761 A1
(43) Pub. Date: Aug. 13, 2026

(54) CONTROL SYSTEM FOR WORK VEHICLE AND CONTROL METHOD FOR WORK VEHICLE

(71) Applicant: KOMATSU LTD., Tokyo (JP)

(72) Inventors: Shunsuke Iijima, Tokyo (JP); Takumi Morikawa, Tokyo (JP); Kazushi Kawamura, Tokyo (JP); Taisuke Goto, Tokyo (JP); Takahiro Matsui, Tokyo (JP); Yoshito Kinoshita, Tokyo (JP)

(73) Assignee: KOMATSU LTD., Tokyo (JP)

(21) Appl. No.: 19/471,128

(22) PCT Filed: Mar. 19, 2024
(86) PCT No.: PCT/JP2024/010652

§ 371 Date: Sep. 30, 2025

(30) Foreign Application Priority Data
Apr. 24, 2023 (JP) 2023-071061

(51) Int. Cl. B60W 60/00; B60W 10/18; B60W 30/14; B60W 50/02; B60W 50/029

(52) U.S. Cl. CPC B60W 60/0051; B60W 10/182; B60W 30/146; B60W 50/0205; B60W 50/029; B60W 60/0015; B60W 2050/022; B60W 2300/125

(57) ABSTRACT

A control system for a work vehicle capable of switching between a manned operation state and an unmanned control state includes an in-vehicle controller and a retarder mechanism that generates a braking force for decelerating the work vehicle. The in-vehicle controller switches from the manned operation state to the unmanned control state in a state where the retarder mechanism is in an operative state.

### TECHNICAL FIELD

The present disclosure relates to a control system for a work vehicle and a control method for a work vehicle.

### BACKGROUND ART

In a technical field related to work vehicles, a transport vehicle capable of switching between an autonomous mode and a manual mode as disclosed in Patent Literature 1 is known.

### CITATION LIST

### Patent Literature

Patent Literature 1: WO 2016/051501 A

### SUMMARY OF INVENTION

### Technical Problem

In a case where the work vehicle is switched from a manned operation state (manual mode) to an unmanned control state (autonomous mode), it is necessary to switch the state under an appropriate condition.

An object of the present disclosure is to switch a work vehicle from a manned operation state to an unmanned control state under an appropriate condition.

### Solution to Problem

According to the present disclosure, there is provided a control system for a work vehicle capable of switching between a manned operation state and an unmanned control state, the control system including: an in-vehicle controller; and a retarder mechanism that generates a braking force for decelerating the work vehicle, wherein the in-vehicle controller switches from the manned operation state to the unmanned control state in a state where the retarder mechanism is in an operative state.

### Advantageous Effects of Invention

According to the present disclosure, it is possible to switch a work vehicle from a manned operation state to an unmanned control state under an appropriate condition.

### BRIEF DESCRIPTION OF DRAWINGS

FIG. 1 is a perspective view illustrating a work vehicle according to an embodiment.

FIG. 2 is a view illustrating a cab of the work vehicle according to the embodiment.

FIG. 3 is a block diagram illustrating a control system for the work vehicle according to the embodiment.

FIG. 4 is a flowchart illustrating a control method for the work vehicle according to the embodiment.

FIG. 5 is a flowchart illustrating the control method for the work vehicle according to the embodiment.

FIG. 6 is a block diagram illustrating a computer system according to the embodiment.

FIG. 7 is a block diagram illustrating the control system for the work vehicle according to the embodiment.

### DESCRIPTION OF EMBODIMENTS

Hereinafter, embodiments according to the present disclosure will be described with reference to the drawings, but the present disclosure is not limited to the embodiments. The components of the embodiments to be described below can be appropriately combined.

Furthermore, some components may not be used.

### Work Vehicle

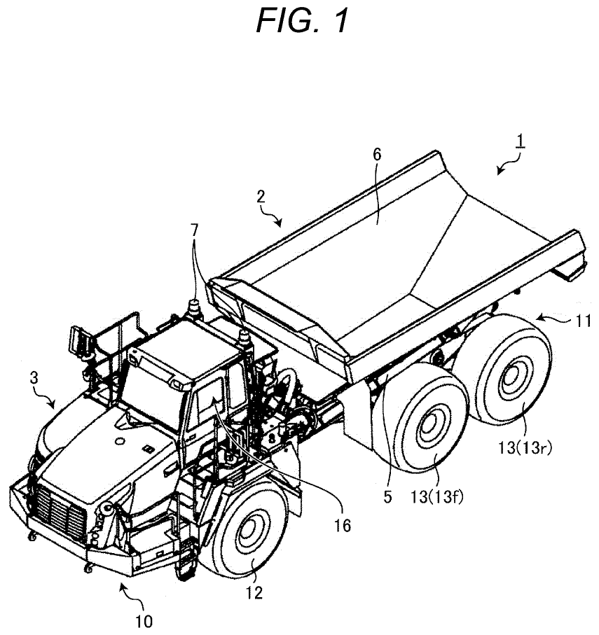

FIG. 1 is a diagram schematically illustrating a work vehicle 1 according to an embodiment. In the embodiment, the work vehicle 1 is an articulated dump truck that is a type of a transport vehicle.

In the embodiment, the work vehicle 1 can be switched between an unmanned control state (autonomous mode) and a manned operation state (manual mode). The manned operation state refers to a state in which the work vehicle 1 operates on the basis of a driving operation by an operator on the work vehicle 1. The unmanned control state refers to a state in which the work vehicle 1 operates on the basis of a control command without depending on the driving operation by the operator on the work vehicle 1.

As illustrated in FIG. 1, the work vehicle 1 includes a vehicle rear part 2 and a vehicle front part 3. The vehicle rear part 2 is provided behind the vehicle front part 3.

The vehicle rear part 2 includes a rear frame 11, a rear wheel 13, a hoist cylinder 5, and a dump body 6. The rear frame 11 constitutes a vehicle body frame of the vehicle rear part 2.

The rear wheel 13 is supported by the rear frame 11 via an axle. A pair of the rear wheels 13 is provided to be separated from each other in a vehicle width direction. In the embodiment, the rear wheels 13 are drive wheels of the work vehicle 1. When the rear wheels 13 rotate, the work vehicle 1 moves forward or backward. Note that, in the embodiment, the rear wheel 13 includes a rear front wheel 13f and a rear rear wheel 13r.

The hoist cylinder 5 is a cylinder for raising and lowering the dump body 6. One end portion of the hoist cylinder 5 is rotatably coupled to the rear frame 11 via a bracket (not illustrated). The other end portion of the hoist cylinder 5 is rotatably coupled to the dump body 6 via a bracket (not illustrated). The dump body 6 is a member on which a load is loaded. The dump body 6 moves up or down by an operation of the hoist cylinder 5.

The vehicle front part 3 includes a front frame 10, a front wheel 12, and a cab 16. The front frame 10 constitutes the vehicle body frame of the vehicle front part 3. A rear portion of the front frame 10 and a front portion of the rear frame 11 are rotatably coupled by a coupling member (not illustrated). The front frame 10 and the rear frame 11 can rotate about an up-down rotation shaft extending in an up-down direction. The work vehicle 1 can turn by moving forward or backward in a state where the front frame 10 and the rear frame 11 rotate. The front frame 10 and the rear frame 11 can also rotate about a front-rear rotation shaft extending in a front-rear direction.

The front wheel 12 is supported by the front frame 10 via an axle. A pair of the front wheels 12 is provided to be separated from each other in the vehicle width direction. The rear wheel 13 is supported by a front portion of the rear frame 11 via an axle. In the embodiment, the front wheels 12 are drive wheels of the work vehicle 1. When the front wheels 12 rotate, the work vehicle 1 moves forward or backward.

The cab 16 is provided above the front frame 10. A rotary lamp 7 is disposed on each of a left side and a right side of the rear portion of the cab 16.

The work vehicle 1 includes a power source 47, a transmission 48, a service brake 49, a retarder mechanism 45, a parking brake 44, a differential device 54, and a differential lock mechanism 46. The power source 47 is a device that supplies power for driving the work vehicle 1. The transmission 48 is a device for transmitting the power from the power source 47 to the front wheels 12 and the rear wheels 13. The service brake 49 is a device that generates a braking force for decelerating and stopping the work vehicle 1. The retarder mechanism 45 is a device that generates an auxiliary braking force for decelerating the work vehicle 1. The parking brake 44 is a device for keeping the work vehicle 1 in a stopped state. The differential device 54 is a device for absorbing a rotational speed difference generated in the drive wheels of the work vehicle 1. The differential device 54 is not limited to a differential device for absorbing the rotational speed difference between the left and right wheels. The differential device 54 may be, for example, an inter-axle differential that is a device for absorbing a rotational speed difference between the front wheel 12 and the rear wheel 13. The differential lock mechanism 46 is a device for fixing the differential device 54.

### Cab

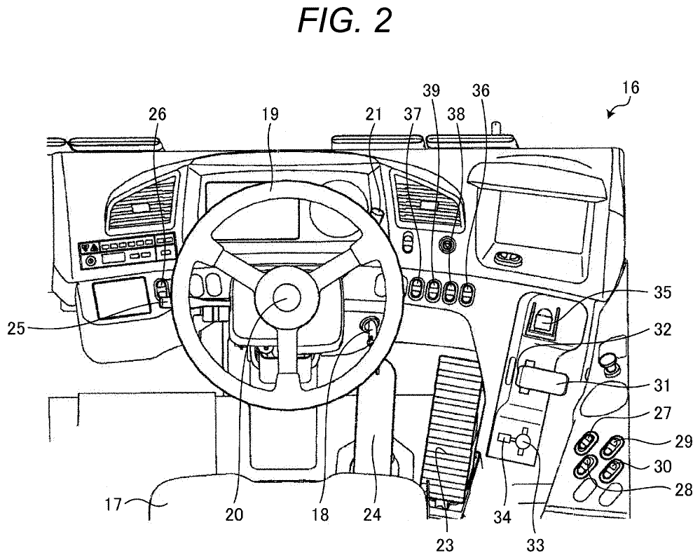

FIG. 2 is a view illustrating the cab 16 of the work vehicle 1 according to the embodiment. As illustrated in FIG. 2, a plurality of operation devices for the operator to board the work vehicle 1 and operate the work vehicle 1 are arranged in the cab 16. In the embodiment, an activation switch 18, a steering wheel 19, a horn button 20, a retarder operation lever 21, an accelerator pedal 23, a service brake pedal 24, a blinker lever 25, a headlight switch 26, a side lamp switch 28, a fog lamp switch 29, a rotary lamp switch 30, a shift lever 31, a shift hold switch 32, a hoist lever 33, a hoist lever lock switch 34, a parking brake switch 35, a power mode changeover switch 36, a differential lock switch 37, a control mode changeover switch 38, and an emergency stop switch 39 are disposed as operation devices in the cab 16.

The activation switch 18 is operated by the operator to activate the work vehicle 1. In the embodiment, the activation switch 18 is a key switch. The activation switch 18 can be operated to any one of an off-position, an on-position, and a start position. When the activation switch 18 is operated from the off-position to the on-position by the operator, a control system for the work vehicle 1 is activated. When the activation switch 18 is operated from the off-position to the start position via the on-position by the operator, the power source 47 of the work vehicle 1 is activated. When the operator releases his/her hand from the activation switch 18, the activation switch 18 returns from the start position to the on-position. The activation of the work vehicle 1 is continued in a state where the activation switch 18 is disposed at the on-position.

The steering wheel 19 is operated by the operator to move the work vehicle 1 straight or turn. In the manned operation state, when the steering wheel 19 is operated, the work vehicle 1 is controlled to travel straight or turn. The steering wheel 19 includes a steering sensor for detecting a steering operation. The steering sensor is, for example, an angle sensor that detects a rotation angle of the steering wheel 19.

The horn button 20 is operated by the operator so that a warning sound is output from a horn 42 of the work vehicle 1. In the manned operation state, when the horn button 20 is operated, the warning sound is output from the horn 42.

The retarder operation lever 21 is a first operation device operated by the operator to decelerate the work vehicle 1. In the manned operation state, when the retarder operation lever 21 is operated, the retarder mechanism 45 is controlled to operate. For example, when the retarder operation lever 21 is operated at the time of downhill of the work vehicle 1, the retarder mechanism 45 operates to generate the auxiliary braking force for decelerating the work vehicle 1.

In the embodiment, the retarder operation lever 21 can be operated by the operator to adjust the braking force of the retarder mechanism 45. An operation amount of the retarder operation lever 21 when the retarder operation lever 21 is operated so that the braking force of the retarder mechanism 45 becomes the largest is set to 100%.

The operation amount of the retarder operation lever 21 being 100% means that the retarder mechanism 45 is operated so that the braking force becomes the largest. The operation amount of the retarder operation lever 21 being 0% means that the retarder mechanism 45 does not operate.

The accelerator pedal 23 is operated by the operator so that the work vehicle 1 accelerates. In the manned operation state, when the accelerator pedal 23 is operated, the work vehicle 1 is controlled to accelerate.

In the embodiment, the operation amount of the accelerator pedal 23 when the accelerator pedal 23 is operated so that an acceleration force of the work vehicle 1 becomes the largest is set to 100%. The operation amount of the accelerator pedal 23 being 100% means that the acceleration force of the work vehicle 1 becomes the largest. The operation amount of the accelerator pedal 23 being 0% means that the acceleration force of the work vehicle 1 is not exerted.

The service brake pedal 24 is operated by the operator to brake the work vehicle 1. In the manned operation state, when the service brake pedal 24 is operated, the service brake 49 is controlled to operate.

In the embodiment, the operation amount of the service brake pedal 24 when the service brake pedal 24 is operated so that the braking force of the service brake 49 becomes the largest is set to 100%. The operation amount of the service brake pedal 24 being 100% means that the service brake 49 is operated so that the braking force becomes the largest. The operation amount of the service brake pedal 24 being 0% means that the service brake 49 does not operate.

The shift lever 31 is operated by the operator to control the transmission 48. In the manned operation state, when the shift lever 31 is operated, a traveling direction of the work vehicle 1 is switched. In addition, a gear ratio of the transmission 48 is changed and torque and rotational speed transmitted from the power source 47 to the drive wheels are changed when the shift lever 31 is operated.

In the embodiment, a forward position, a neutral position, and a reverse position are defined in a movable range of the shift lever 31. In a case where the shift lever 31 is disposed at the forward position, the work vehicle 1 is controlled to move forward. In a case where the shift lever 31 is disposed at the reverse position, the work vehicle 1 is controlled to move backward. In a case where the shift lever 31 is disposed at the neutral position, the transmission 48 is in a state of not transmitting the power from the power source 47 to the drive wheels.

The shift hold switch 32 is operated by the operator to hold the position of the shift lever 31 or to release the holding of the position of the shift lever 31. In the manned operation state, the position of the shift lever 31 is held when the shift hold switch 32 is operated.

In the embodiment, the shift hold switch 32 is operated to be either on or off. Turning on the shift hold switch 32 means that the position of the shift lever 31 is held. Turning off the shift hold switch 32 means that the holding of the position of the shift lever 31 is released.

The hoist lever 33 is operated by the operator to raise or lower the dump body 6. In the manned operation state, the hoist cylinder 5 operates when the hoist lever 33 is operated. When the hoist lever 33 is operated, the hoist cylinder 5 expands or contracts, and the dump body 6 moves up or down.

In the embodiment, a raising position, a holding position, a floating position, and a lowering position are defined in the movable range of the hoist lever 33. In a case where the hoist lever 33 is disposed at the raising position, the dump body 6 is controlled to rise. In a case where the hoist lever 33 is disposed at the holding position, the dump body 6 is controlled to maintain the stopped state. In a case where the hoist lever 33 is disposed at the floating position, the dump body 6 is controlled to freely move with an external force. In a case where the hoist lever 33 is disposed at the lowering position, the dump body 6 is controlled to descend.

The hoist lever lock switch 34 is operated by the operator to lock the hoist lever 33. In the manned operation state, the hoist lever 33 becomes unmovable when the hoist lever lock switch 34 is operated.

The parking brake switch 35 is operated by the operator to operate the parking brake 44. In the manned operation state, the parking brake 44 is engaged or disengaged when the parking brake switch 35 is operated.

In the embodiment, the parking brake switch 35 is operated to be either on or off. Turning on the parking brake switch 35 means that the parking brake 44 is engaged. Engaging the parking brake 44 means that the stopped state of the work vehicle 1 is maintained. Turning off the parking brake switch 35 means that the parking brake 44 is disengaged.

The power mode changeover switch 36 is operated by the operator to switch an output characteristic of the power source 47. In the manned operation state, the output characteristic of the power source 47 changes when the power mode changeover switch 36 is operated.

The differential lock switch 37 is operated by the operator to operate the differential lock mechanism 46. In the manned operation state, the differential device 54 is fixed or opened when the differential lock switch 37 is operated.

In the embodiment, the differential lock switch 37 is operated to be either on or off. Turning on the differential lock switch 37 means that the differential lock mechanism 46 is operated and the differential device 54 is fixed. Turning off the differential lock switch 37 means that the differential lock mechanism 46 is not operated and the differential device 54 is opened.

The control mode changeover switch 38 is operated by the operator to switch the work vehicle 1 between the manned operation state and the unmanned control state. In the manned operation state, the work vehicle 1 can be switched between the manned operation state and the unmanned control state when the control mode changeover switch 38 is operated.

In the embodiment, the control mode changeover switch 38 is operated so that the work vehicle 1 is in one of the manned operation state or the unmanned control state. Operating the control mode changeover switch 38 to the manned operation state means selecting the manned operation state for the work vehicle 1. Operating the control mode changeover switch 38 to the unmanned control state means selecting the unmanned control state for the work vehicle 1.

The emergency stop switch 39 is operated by the operator to make an emergency stop of the work vehicle 1. In the manned operation state, the traveling work vehicle 1 is urgently stopped when the emergency stop switch 39 is operated.

In the embodiment, the emergency stop switch 39 is operated to be either on or off. Turning on the emergency stop switch 39 means to urgently stop the traveling work vehicle 1. Turning off the emergency stop switch 39 means that the emergency stop of the work vehicle 1 is released.

### Control System

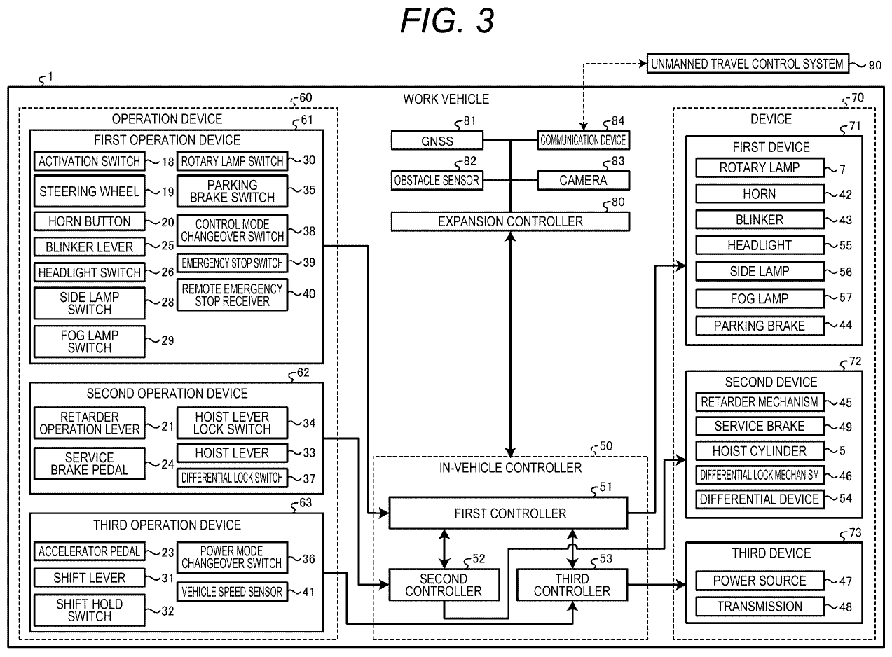

FIG. 3 is a block diagram illustrating the control system for the work vehicle 1 according to the embodiment. The control system switches the work vehicle 1 between the manned operation state and the unmanned control state. As illustrated in FIG. 3, the control system includes an in-vehicle controller 50, an operation device 60, a device 70, an expansion controller 80, a position sensor 81, an obstacle sensor 82, a camera 83, a communication device 84, and an unmanned travel control system 90.

Each of the in-vehicle controller 50, the operation device 60, the device 70, the expansion controller 80, the position sensor 81, the obstacle sensor 82, the camera 83, and the communication device 84 is mounted on the work vehicle 1. For example, the expansion controller 80 may be disposed outside the work vehicle 1. The unmanned travel control system 90 is disposed outside the work vehicle 1.

The unmanned travel control system 90 transmits target data indicating a target position of the work vehicle 1 in the unmanned control state to the work vehicle 1. The target data transmitted from the unmanned travel control system 90 to the work vehicle 1 includes a target arrival position of the work vehicle 1. Note that the target data transmitted from the unmanned travel control system 90 to 1 may include a target via position of the work vehicle 1. The target position is defined in a global coordinate system, for example.

The communication device 84 receives the target data from the unmanned travel control system 90. The target data received by the communication device 84 is transmitted to the expansion controller 80.

The position sensor 81 detects the position of the work vehicle 1. The position sensor 81 detects the position of the work vehicle 1 using a global navigation satellite system (GNSS). The global navigation satellite system includes a global positioning system (GPS). The global navigation satellite system detects the position defined by coordinate data of latitude, longitude, and altitude. The position sensor 81 includes a GNSS receiver that receives GNSS radio waves from a GNSS satellite. Detection data of the position sensor 81 is transmitted to the expansion controller 80.

The obstacle sensor 82 detects an obstacle around the work vehicle 1. The obstacle sensor 82 detects an obstacle in a non-contact manner with the obstacle. Examples of the obstacle sensor 82 include a laser sensor (light detection and ranging (LIDAR)) that detects the obstacle by emitting laser light. Note that the obstacle sensor 82 may be a radar sensor (radio detection and ranging (RADAR)) that detects the obstacle by emitting radio waves, or may be an infrared sensor that detects the obstacle by emitting infrared light.

The camera 83 captures an image of a periphery of the work vehicle 1. The camera 83 may capture an image of the obstacle of the work vehicle 1.

The expansion controller 80 outputs a control command for controlling the work vehicle 1 in the unmanned control state. The expansion controller 80 outputs the control command for controlling the work vehicle 1 on the basis of the target data transmitted from the unmanned travel control system 90 and the detection data of the position sensor 81.

In the embodiment, the expansion controller 80 calculates a target route to a target arrival position on the basis of the target data transmitted from the unmanned travel control system 90. The target route is defined in the global coordinate system, for example. The control command output from the expansion controller 80 includes a target traveling speed and a target steering angle when the work vehicle 1 travels along the target route. The expansion controller 80 outputs the control command including the target traveling speed and the target steering angle on the basis of the detection data of the position sensor 81 so that the work vehicle 1 travels along the target route. The control command output from the expansion controller 80 is transmitted to the in-vehicle controller 50.

Further, the control command output from the expansion controller 80 includes an accelerator control command, a shift control command, a retarder control command, a parking brake control command, and a hoist control command.

The accelerator control command is a control command for accelerating the work vehicle 1. In the unmanned control state, the work vehicle 1 accelerates on the basis of the accelerator control command.

In the embodiment, it is assumed that the accelerator control command that maximizes the acceleration force of the work vehicle 1 is set to 100%, and the accelerator control command that does not exert the acceleration force of the work vehicle 1 is set to 0%.

The shift control command is a control command for controlling the transmission 48. In the unmanned control state, the transmission 48 operates on the basis of the shift control command.

In the embodiment, the shift control command includes a forward command for moving the work vehicle 1 forward, a reverse command for moving the work vehicle 1 backward, and a neutral command for placing the transmission 48 in a neutral state.

The retarder control command is a control command for operating the retarder mechanism 45. In the unmanned control state, the retarder mechanism 45 operates on the basis of the retarder control command.

In the embodiment, it is assumed that the retarder control command that maximizes the braking force of the retarder mechanism 45 is set to 100%, and the retarder command in a case where the retarder mechanism 45 is not operated is set to 0%.

The parking brake control command is a control command for operating the parking brake 44. In the unmanned control state, the parking brake 44 operates on the basis of the parking brake control command.

In the embodiment, in a case where a parking brake command is on, the parking brake 44 is engaged, and in a case where the parking brake command is off, the parking brake 44 is disengaged.

The hoist control command is a control command for operating the hoist cylinder 5. In the unmanned control state, the hoist cylinder 5 operates on the basis of the hoist control command.

In the embodiment, the hoist control command includes a raising command for raising the dump body 6, a holding command for maintaining the stopped state of the dump body 6, a floating command for making the dump body 6 freely movable with an external force, and a lowering command for lowering the dump body 6.

In the embodiment, the expansion controller 80 can output a mode switching signal for switching the work vehicle 1 between the manned operation state and the unmanned control state. The mode switching signal includes a manned signal for bringing the work vehicle 1 into the manned operation state and an unmanned signal for bringing the work vehicle 1 into the unmanned control state.

The in-vehicle controller 50 controls the device 70 of the work vehicle 1. In the embodiment, the in-vehicle controller 50 includes a first controller 51, a second controller 52, and a third controller 53. In the embodiment, the operation device 60 includes a first operation device 61, a second operation device 62, and a third operation device 63. In the embodiment, the device 70 includes a first device 71, a second device 72, and a third device 73.

Note that, in the embodiment, the in-vehicle controller 50 includes the three controllers (51, 52, and 53), but the number of controllers included in the in-vehicle controller 50 is not limited to three. For example, one controller may have the function of the second controller 52 and the function of the third controller 53, or one controller may have the function of the first controller 51, the function of the second controller 52, and the function of the third controller 53.

Note that, in the embodiment, the operation device 60 includes the three operation devices (61, 62, and 63), but the number of operation devices included in the operation device 60 is not limited to three. For example, one operation device may have the function of the second operation device 62 and the function of the third operation device 63, or one operation device may have the function of the first operation device 61, the function of the second operation device 62, and the function of the third operation device 63.

Note that, in the embodiment, the device 70 includes the three devices (71, 72, and 73), but the number of devices included in the device 70 is not limited to three. For example, one device may have the function of the second device 72 and the function of the third device 73, or one device may have the function of the first device 71, the function of the second device 72, and the function of the third device 73.

The first operation device 61 includes the activation switch 18, the steering wheel 19, the horn button 20, a blinker lever 25, the headlight switch 26, the side lamp switch 28, the fog lamp switch 29, the rotary lamp switch 30, the parking brake switch 35, the control mode changeover switch 38, the emergency stop switch 39, and a remote emergency stop signal receiver 40. Input data from the first operation device 61 is transmitted to the first controller 51. The input data from the first operation device 61 includes an operation signal generated by operating at least one of the activation switch 18, the steering wheel 19, the horn button 20, the blinker lever 25, the headlight switch 26, the side lamp switch 28, the fog lamp switch 29, the rotary lamp switch 30, the parking brake switch 35, the control mode changeover switch 38, or the emergency stop switch 39.

The remote emergency stop signal receiver 40 receives an emergency stop signal transmitted from a remote operation device outside the work vehicle 1. For example, a manager existing outside the work vehicle 1 can operate the remote operation device to emergently stop the work vehicle 1. When the remote operation device is operated, the emergency stop signal is transmitted from the remote operation device to the work vehicle 1. The input data transmitted from the first operation device 61 to the first controller 51 includes the emergency stop signal received by the remote emergency stop signal receiver 40.

The second operation device 62 includes the retarder operation lever 21, the service brake pedal 24, the hoist lever 33, the hoist lever lock switch 34, and the differential lock switch 37. Input data from the second operation device 62 is transmitted to the second controller 52. The input data from the second operation device 62 includes an operation signal generated by operating at least one of the retarder operation lever 21, the service brake pedal 24, the hoist lever 33, the hoist lever lock switch 34, or the differential lock switch 37.

The third operation device 63 includes the accelerator pedal 23, the shift lever 31, the shift hold switch 32, the power mode changeover switch 36, and a vehicle speed sensor 41. Input data from the third operation device 63 is transmitted to the third controller 53. The input data from the third operation device 63 includes an operation signal generated by operating at least one of the accelerator pedal 23, the shift lever 31, the shift hold switch 32, or the power mode changeover switch 36.

The vehicle speed sensor 41 detects the traveling speed of the work vehicle 1. The vehicle speed sensor 41 detects the traveling speed of the work vehicle 1 by, for example, detecting a rotation speed of the axle connected to the drive wheel. The input data from the third operation device 63 includes detection data of the vehicle speed sensor 41.

The first controller 51 communicates with each of the second controller 52 and the third controller 53. The first controller 51 controls the first device 71 on the basis of the input data from the first operation device 61. The first controller 51 transmits the control command transmitted from the expansion controller 80 to the first device 71. In the manned operation state, the first controller 51 controls the first device 71 on the basis of the input data from the first operation device 61. In the unmanned control state, the first controller 51 transmits the control command transmitted from the expansion controller 80 to the first device 71.

The second controller 52 controls the second device 72 on the basis of the input data from the second operation device 62. The second controller 52 transmits the control command transmitted from the expansion controller 80 via the first controller 51 to the second device 72. In the manned operation state, the second controller 52 controls the second device 72 on the basis of the input data from the second operation device 62. In the unmanned control state, the second controller 52 transmits the control command transmitted from the expansion controller 80 via the first controller 51 to the second device 72.

The third controller 53 controls the third device 73 on the basis of the input data from the third operation device 63. The third controller 53 transmits the control command transmitted from the expansion controller 80 via the first controller 51 to the third device 73. In the manned operation state, the third controller 53 controls the third device 73 on the basis of the input data from the third operation device 63. In the unmanned control state, the third controller 53 transmits the control command transmitted from the expansion controller 80 via the first controller 51 to the third device 73.

The first device 71 includes the rotary lamp 7, the horn 42, a blinker 43, a headlight 55, a side lamp 56, a fog lamp 57, and the parking brake 44. The first device 71 is controlled by the first controller 51. The first device 71 operates on the basis of the control command from the first controller 51.

The second device 72 includes the retarder mechanism 45, the service brake 49, the hoist cylinder 5, the differential lock mechanism 46, and the differential device 54. The second device 72 is controlled by the second controller 52. The second device 72 operates on the basis of the control command from the second controller 52.

The third device 73 includes the power source 47 and the transmission 48. The third device 73 is controlled by the third controller 53. The third device 73 operates on the basis of the control command from the third controller 53.

### Control Method

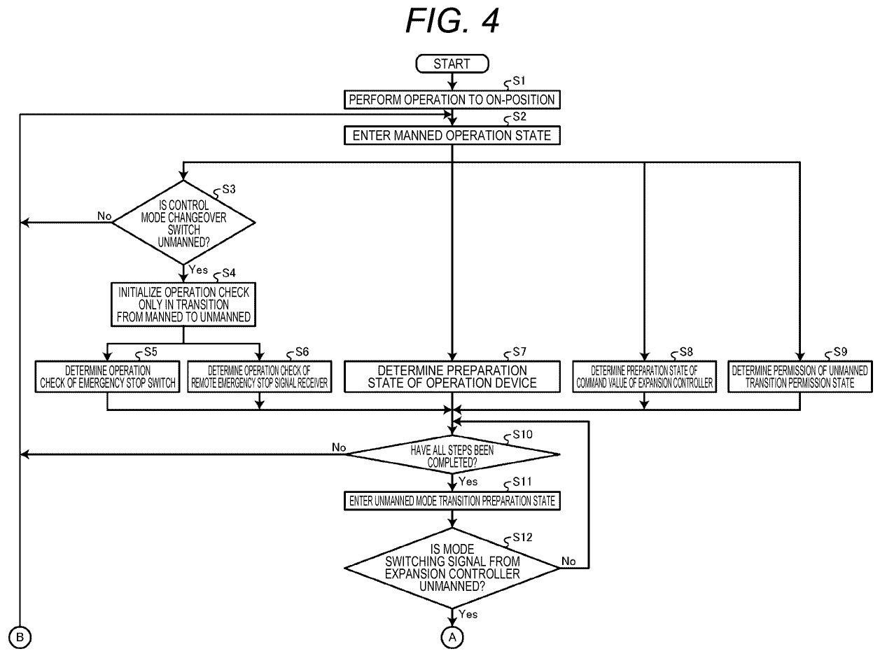

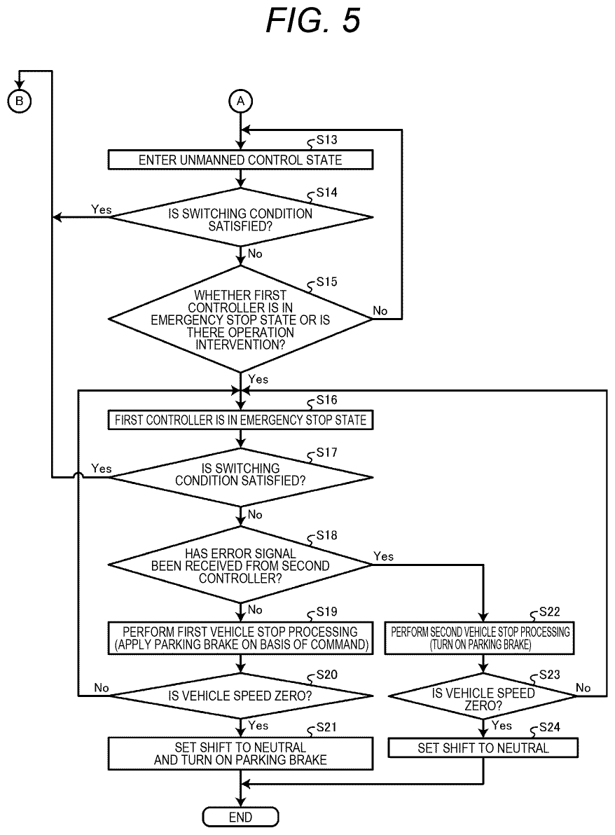

FIGS. 4 and 5 are flowcharts illustrating a control method for the work vehicle 1 according to the embodiment.

The activation switch 18 is operated to the on-position by the operator boarding the cab 16 (step S1). When the activation switch 18 is operated to the on-position, the in-vehicle controller 50 is activated, and the in-vehicle controller 50 is initialized. Operation check of each of the emergency stop switch 39 and the remote emergency stop signal receiver 40 by the first controller 51 is incomplete.

When the activation switch 18 is operated to the on-position, the work vehicle 1 enters the manned operation state (step S2).

The first controller 51 determines whether the control mode changeover switch 38 has been selected in the unmanned control state (step S3).

In a case where it is determined in step S3 that the control mode changeover switch 38 has been selected in the manned operation state (step S3: No), the work vehicle 1 is in the manned operation state (step S2).

In a case where it is determined in step S3 that the control mode changeover switch 38 has been operated in the unmanned control state (step S3: Yes), the first controller 51 initializes the operation check of the control mode changeover switch 38 only when the control mode changeover switch 38 is operated to transition from the manned operation state to the unmanned control state (step S4). In step S4, the operation check of each of the emergency stop switch 39 and the remote emergency stop signal receiver 40 by the first controller 51 is incomplete.

The first controller 51 determines the operation check of the emergency stop switch 39 (step S5). In a case where the operator operates the emergency stop switch 39 to a predetermined operation state and the first controller 51 confirms the operation of the emergency stop switch 39, the operation check of the emergency stop switch 39 is completed. In a case where the operation of emergency stop switch 39 cannot be confirmed, the operation check of the emergency stop switch 39 is incomplete. As an example, the predetermined operation state of the emergency stop switch 39 is a state in which the emergency stop switch 39 is operated from on to off after being operated from off to on.

The first controller 51 determines the operation check of the remote emergency stop signal receiver 40 (step S6). In a case where the operator operates the remote operation device outside the work vehicle 1 and confirms that the remote emergency stop signal receiver 40 has received the emergency stop signal from the remote operation device, the first controller 51 determines that the operation check of the remote emergency stop signal receiver 40 has been completed. In a case where the operation of the remote emergency stop signal receiver 40 cannot be confirmed, it is determined that the operation check of the remote emergency stop signal receiver 40 is incomplete.

The first controller 51 determines a preparation state of the operation device 60 (step S7). In a case where the operation device 60 satisfies the following conditions (a1) to (a6), it is determined that the preparation state of the operation device 60 is completed. In a case where the operation device 60 does not satisfy the following conditions (a1) to (a6), it is determined that the preparation state of the operation device 60 is incomplete.

(a1) The operation amount of the accelerator pedal 23:0%

(a2) The position of the shift lever 31: neutral position

(a3) The operation amount of the retarder operation lever 21:100%

(a4) The parking brake switch 35: ON

(a5) The position of the hoist lever 33: holding position

(a6) The detection data of the vehicle speed sensor 41:0 km/h

The first controller 51 determines a command value preparation state of the expansion controller 80 (step S8).

In a case where the control command from the expansion controller 80 satisfies the following conditions (b1) to (b5), it is determined that the command value preparation state of the expansion controller 80 is completed. In a case where the control command from the expansion controller 80 does not satisfy the following conditions (b1) to (b5), it is determined that the command value preparation state of the expansion controller 80 is incomplete.

(b1) The accelerator control command: 0%

(b2) The shift control command: neutral command

(b3) The retarder control command: 100%

(b4) The parking brake control command: ON

(b5) The hoist control command: holding command

The first controller 51 determines permission of an unmanned transition permission state (step S9). In a case where a first error condition of the first controller 51 is not satisfied and a second error condition of the first controller 51 is not satisfied, it is determined that the permission of the unmanned transition permission state is completed. In a case where the first error condition of the first controller 51 is satisfied or the second error condition of the first controller 51 is satisfied, it is determined that the permission of the unmanned transition permission state is incomplete.

The first error condition of the first controller 51 refers to the following conditions (c1) to (c3). For example, in the unmanned control state, in the case where the first error condition is satisfied, the unmanned control state is forcibly transitioned to the manned operation state.

(c1) Power supply system failure of the first controller 51

(c2) Failure of the control mode changeover switch 38

(c3) Poor communication between the first controller 51 and at least one of the second controller 52 or the third controller 53

The second error condition of the first controller 51 refers to the following conditions (d1) and (d2). For example, in the unmanned control state, in the case where the second error condition is satisfied, the work vehicle 1 is stopped.

(d1) The emergency stop signal or an error signal from the expansion controller 80 is received

(d2) The emergency stop signal is received from at least one of the second controller 52 or the third controller 53

The first controller 51 determines whether or not all the determinations of steps S5 to S9 have been completed (step S10).

In a case where it is determined in step S10 that all the determinations of steps S5 to S9 are not completed (step S10: No), the work vehicle 1 is in the manned operation state (step S2).

In a case where it is determined in step S10 that all the determinations from step S5 to step S9 have been completed (step S10: Yes), the work vehicle 1 enters an unmanned mode transition preparation state (step S11).

Next, the first controller 51 determines whether or not the mode switching signal from the expansion controller 80 is the unmanned signal (step S12).

In a case where the mode switching signal from the expansion controller 80 is the manned signal (step S12: No), the processing returns to step S10.

In a case where the mode switching signal from the expansion controller 80 is the unmanned signal (step S12: Yes), the work vehicle 1 enters the unmanned control state (step S13).

The work vehicle 1 in the unmanned control state travels on the basis of the control command output from the expansion controller 80. The operator boarding the cab 16 remains in the cab 16 as an observer.

As described above, the first controller 51 switches from the manned operation state to the unmanned control state in a state where the retarder mechanism 45 is operated. The first controller 51 determines whether or not the retarder mechanism 45 is in the operated state on the basis of the operation state of the retarder operation lever 21 as the first operation device. As in the above-described condition (a3), the first controller 51 switches from the manned operation state to the unmanned control state on condition that the operation amount of the retarder operation lever 21 is 100%, that is, the retarder operation lever 21 is operated so that the braking force of the retarder mechanism 45 becomes the maximum.

In the embodiment, the first controller 51 switches from the manned operation state to the unmanned control state in a state where the retarder mechanism 45 is operated and in a state where the parking brake 44 is engaged. The first controller 51 determines whether or not the parking brake 44 is in the engaged state on the basis of the operation state of the parking brake switch 35. As in the above-described condition (a4), the first controller 51 switches from the manned operation state to the unmanned control state on condition that the parking brake switch 35 is on.

Further, in the embodiment, the first controller 51 switches from the manned operation state to the unmanned control state in a state where the retarder command that is a control command for turning on the retarder mechanism 45 is output from the expansion controller 80. As in the above-described condition (b3), the first controller 51 switches from the manned operation state to the unmanned control state on condition that the retarder command is 100%, that is, the retarder command is output so that the braking force of the retarder mechanism 45 becomes the maximum.

In the unmanned control state, the first controller 51 monitors that at least the retarder lever is in the operation state of turning on the retarder mechanism 45. In the embodiment, in the unmanned control state, the first controller 51 monitors whether the above-described conditions (a1), (a2), (a3), (a4), and (a5) are satisfied.

The first controller 51 determines whether or not a switching condition to the manned operation state is satisfied (step S14).

Satisfying the switching condition to the manned operation state means satisfying at least one of the following three conditions (e1) to (e3).

(e1) The first error condition of the first controller 51 is satisfied

(e2) The control mode changeover switch 38 is in the manned operation state

(e3) The mode switching signal from the expansion controller 80 is the manned signal

In a case where the switching condition to the manned operation state is satisfied in step S14 (step S14: Yes), the work vehicle 1 enters the manned operation state (step S2).

Since the above-described conditions (a1), (a2), (a3), (a4), and (a5) are maintained at the time of step S14, in a case where the manned operation state is switched to the unmanned operation state, the work vehicle 1 stops according to the operation state of the retarder operation lever 21. That is, at the time of step S14, since the operation amount of the accelerator pedal 23 is 0% (condition (a1)), the operation amount of the retarder operation lever 21 is 100% (condition (a3)), and the parking brake switch 35 is turned on (condition (a4)), in a case where the processing transitions from step S14 to step S2, the work vehicle 1 stops in accordance with the operation state of the retarder operation lever 21, the operation state of the parking brake switch 35, and the operation state of the accelerator pedal 23.

Further, in the case of transition from step S14 to step S2, the operation check performed in steps S5 and S6 is initialized. That is, the operation check of each of the emergency stop switch 39 and the remote emergency stop signal receiver 40 is in an incomplete state.

In step S14, in a case where the switching condition to the manned operation state is not satisfied (step S14: No), the first controller 51 determines whether or not the first controller 51 is in the emergency stop state or there is operation intervention (step S15).

The state in which the first controller 51 is in the emergency stop state refers to the following states (f1) to (f5).

(f1) A state where the emergency stop signal or the error signal from the expansion controller 80 is received

(f2) A state where the emergency stop signal is received from at least one of the second controller 52 or the third controller 53

(f3) A state where the emergency stop switch 39 is turned on

(f4) A state where the emergency stop signal is received from the remote emergency stop signal receiver 40

(f5) A state where the second error condition of the first controller 51 is satisfied

The operation intervention means that at least one of the following first condition or second condition is satisfied in the unmanned control state.

### First Condition: at Least One of the Following States (g1) to (g5) is Satisfied

(g1) The operation amount of the accelerator pedal 23: a state of not 0%

(g2) The position of the shift lever 31: a state not in the neutral position

(g3) The operation amount of the retarder operation lever 21: a state of not 100%

(g4) The parking brake switch 35: an off state

(g5) The position of the hoist lever 33: a state of not the holding position

### Second Condition: a State in Which at Least One of the Following Operation Devices (h1) to (h12) is Operated by the Operator

(h1) Steering wheel 19

(h2) Horn button 20

(h3) Blinker lever 25

(h4) Headlight switch 26

(h5) Side lamp switch 28

(h6) Fog lamp switch 29

(h7) Rotary lamp switch 30

(h8) Shift hold switch 32

(h9) Hoist lever lock switch 34

(h10) Power mode changeover switch 36

(h11) Service brake pedal 24

(h12) Differential lock switch 37

The above-described condition (g1) means that the accelerator pedal 23 in the condition (a1) has been operated by the operator. The above-described condition (g2) means that the shift lever 31 in the condition (a2) has been operated by the operator. The above-described condition (g3) means that the retarder operation lever 21 in the condition (a3) has been operated by the operator. The above-described condition (g4) means that the parking brake switch 35 in the state of the condition (a4) has been operated by the operator. The above-described condition (g5) means that the hoist lever 33 in the condition (a5) has been operated by the operator.

In step S15, in a case where it is determined that the first controller 51 is not in the emergency stop state and there is no operation intervention (step S15: No), the unmanned control state is continued (step S13).

In step S15, in a case where it is determined that the first controller 51 is in the emergency stop state or there is operation intervention (step S15: Yes), the first controller 51 is in the emergency stop state (step S16).

The first controller 51 determines whether or not the switching condition to the manned operation state described above is satisfied (step S17).

In a case where the switching condition to the manned operation state is satisfied in step S17 (step S17: Yes), the work vehicle 1 enters the manned operation state (step S2). Since the above-described conditions (a1), (a2), (a3), (a4), and (a5) are maintained at the time of step S17, in a case of transition from step S17 to step S2, the work vehicle 1 stops in accordance with the operation state of the retarder operation lever 21, the operation state of the parking brake switch 35, and the operation state of the accelerator pedal 23.

Further, in the case of transition from step S17 to step S2, the operation check performed in steps S5 and S6 is initialized. That is, the operation check of each of the emergency stop switch 39 and the remote emergency stop signal receiver 40 is in an incomplete state.

In a case where the switching condition to the manned operation state is not satisfied in step S17 (step S17: No), the first controller 51 determines whether or not the error signal related to the retarder mechanism 45 is received from the second controller 52 (step S18).

The error signal is output from the second controller 52 when at least one of the following conditions (i1) or (i2) is satisfied.

(i1) Power supply system failure of the second controller 52

(i2) Failure of the retarder mechanism 45

In a case where no error signal is received in step S18 (step S18: No), the first controller 51 performs first vehicle stop processing of stopping the work vehicle 1 under a first vehicle stop condition (step S19).

In the first vehicle stop processing, a control command is output from the first controller 51. The first vehicle stop condition refers to the following conditions (j1) to (j5).

(j1) The rotary lamp: turned on

(j2) The accelerator command: 0%

(j3) The retarder command: a command value is increased at each predetermined time from an initial value 40%

(j4) The hoist command: holding command

(j5) The parking brake command: in accordance with the parking brake command from the expansion controller 80

After the first vehicle stop processing, the first controller 51 determines whether or not the vehicle speed is 0 on the basis of the detection data of the vehicle speed sensor 41 (step S20).

In a case where it is determined in step S20 that the vehicle speed is not 0 (step S20: No), the processing returns to step S16.

In a case where it is determined in step S20 that the vehicle speed is 0 (step S20: Yes), the first controller 51 outputs the neutral command to set the transmission 48 to a neutral state. Further, the first controller 51 outputs the parking brake command for locking the parking brake 44 (step S21).

In a case where the error signal is received in step S18 (step S18: Yes), the first controller 51 performs second vehicle stop processing of stopping the work vehicle 1 under a second vehicle stop condition (step S22).

The second vehicle stop condition is different from the first vehicle stop condition. Similarly to the first vehicle stop processing, a control command is output from the first controller 51 in the second vehicle stop processing. The second vehicle stop condition refers to the following conditions (k1) to (k5).

(k1) The rotary lamp: turned on

(k2) The accelerator command: 0%

(k3) The retarder command: a command value is increased at each predetermined time from an initial value 40%

(k4) The hoist command: holding command

(k5) The parking brake command: ON

After the second vehicle stop processing, the first controller 51 determines whether or not the vehicle speed is 0 on the basis of the detection data of the vehicle speed sensor 41 (step S23).

In a case where it is determined in step S23 that the vehicle speed is not 0 (step S23: No), the processing returns to step S16.

In a case where it is determined in step S23 that the vehicle speed is 0 (step S23: Yes), the first controller 51 outputs the neutral command to set the transmission 48 to the neutral state (step S24).

As described above, in the case where there is operation intervention in the unmanned control state, that is, in the case where at least one operation device among the plurality of operation devices arranged in the cab 16 is operated in the unmanned control state as illustrated in the conditions (g1) to (g5) and the conditions (h1) to (h4), the first controller 51 stops the work vehicle 1 (steps S21 and S24).

In the unmanned control state, in the case where there is operation intervention in which at least one of the operation devices is operated and the error signal related to the retarder mechanism 45 is not received, the first controller 51 stops the work vehicle 1 under the first vehicle stop condition (step S19). In the unmanned control state, in the case where there is operation intervention in which at least one of the operation devices is operated and the error signal related to the retarder mechanism 45 is received, the first controller 51 stops the work vehicle 1 under the second vehicle stop condition (step S19).

### Computer System

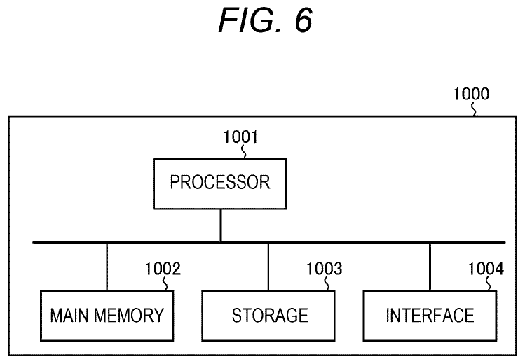

FIG. 6 is a block diagram illustrating a computer system 1000 according to the embodiment. The above-described in-vehicle controller 50 (the first controller 51, the second controller 52, and the third controller 53) includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The functions of the in-vehicle controller 50 described above are stored in the storage 1003 as a computer program. The processor 1001 reads the computer program from the storage 1003 into the main memory 1002, and executes the above-described processing according to the program. Note that the computer program may be distributed to the computer system 1000 via a network.

The computer program or the computer system 1000 can monitor the operation state of the retarder operation lever 21 operated to operate the retarder mechanism 45 that brakes the work vehicle 1, and switch the work vehicle 1 from the manned operation state to the unmanned control state in the state where the retarder operation lever 21 is operated so that the retarder mechanism 45 is operated according to the above-described embodiment.

### Effects

As described above, in the embodiment, the control system for a work vehicle capable of switching between the manned operation state and the unmanned control state includes the in-vehicle controller 50 and the retarder mechanism 45 that generates a braking force for decelerating the work vehicle 1. The in-vehicle controller 50 switches from the manned operation state to the unmanned control state in a state where the retarder mechanism 45 is in an operative state.

According to the embodiment, the work vehicle 1 is switched from the manned operation state to the unmanned control state on condition that the retarder mechanism 45 is in an operative state. Since the manned operation state is switched to the unmanned control state in the state where the work vehicle 1 is stopped, the work vehicle 1 is switched from the manned operation state to the unmanned control state under an appropriate condition.

The in-vehicle controller 50 determines whether the retarder mechanism 45 is in an operative state on the basis of an operation state of the retarder operation lever 21, which is a first operation device operated to operate the retarder mechanism 45. As a result, the in-vehicle controller 50 can recognize that the retarder mechanism 45 is in an operative state on the basis of the operation state of the retarder operation lever 21.

The in-vehicle controller 50 switches from the manned operation state to the unmanned control state in a state where the parking brake 44 for maintaining the stopped state of the work vehicle 1 is engaged. The work vehicle 1 is switched from the manned operation state to the unmanned control state on condition that the parking brake 44 is engaged. Since the manned operation state is switched to the unmanned control state in the state where the work vehicle 1 is stopped, the work vehicle 1 is switched from the manned operation state to the unmanned control state under an appropriate condition.

The control system includes the expansion controller 80 that outputs the control command for controlling the work vehicle 1 in the unmanned control state. The in-vehicle controller 50 switches from the manned operation state to the unmanned control state in the state where the retarder command that is the control command for operating the retarder mechanism 45 is output from the expansion controller 80. The work vehicle 1 is switched from the manned operation state to the unmanned control state on condition that the retarder command is output. Since the stopped state of the work vehicle 1 is maintained after the manned operation state is switched to the unmanned control state, the work vehicle 1 is switched from the manned operation state to the unmanned control state under an appropriate condition. For example, immediately after the work vehicle 1 is switched from the manned operation state to the unmanned control state, sudden start of the work vehicle 1 is suppressed.

In the unmanned control state, the in-vehicle controller 50 monitors that the retarder operation lever 21 is in the operation state of operating the retarder mechanism 45. Since it is maintained that the retarder operation lever 21 is in the operation state of operating the retarder mechanism 45 in the unmanned control state, the work vehicle 1 can be stopped after the work vehicle 1 is switched from the unmanned operation state to the unmanned control state.

In the case where the unmanned control state is switched to the manned operation state, the work vehicle 1 stops according to the operation state of the retarder operation lever 21. Since it is maintained that the retarder operation lever 21 is in the operation state of operating the retarder mechanism 45 in the unmanned control state, the work vehicle 1 can be stopped after the work vehicle 1 is switched from the unmanned control state to the manned operation state.

In a case where there is operation intervention in which at least one of the plurality of operation devices is operated in the unmanned control state, the in-vehicle controller 50 outputs the control command for stopping the work vehicle 1. In a case where the operator (observer) erroneously operates the operation device in the unmanned control state, the work vehicle 1 stops. The operator can take a process for switching from the unmanned control state to the manned operation state, for example, in the state where the work vehicle 1 is stopped.

In the unmanned control state, in the case where there is operation intervention in which at least one of the operation devices is operated and the error signal related to the retarder mechanism 45 is not received, the in-vehicle controller 50 stops the work vehicle 1 under the first vehicle stop condition. In the unmanned control state, in the case where there is operation intervention in which at least one of the operation devices is operated and the error signal related to the retarder mechanism 45 is received, the in-vehicle controller 50 stops the work vehicle 1 under the second vehicle stop condition. In the case where no error signal related to the retarder mechanism 45 is output, the parking brake command output from the in-vehicle controller 50 (first controller 51) is output in accordance with the parking brake command from the expansion controller 80, so that the parking brake 44 can be appropriately engaged. In the case where the error signal related to the retarder mechanism 45 is output, the parking brake 44 is engaged on the basis of the parking brake command output from the in-vehicle controller 50 (first controller 51), so that the parking brake 44 can be appropriately engaged.

### Other Embodiments

In the above-described embodiment, the work vehicle 1 has been an articulated dump truck. The work vehicle 1 may be a rigid dump truck.

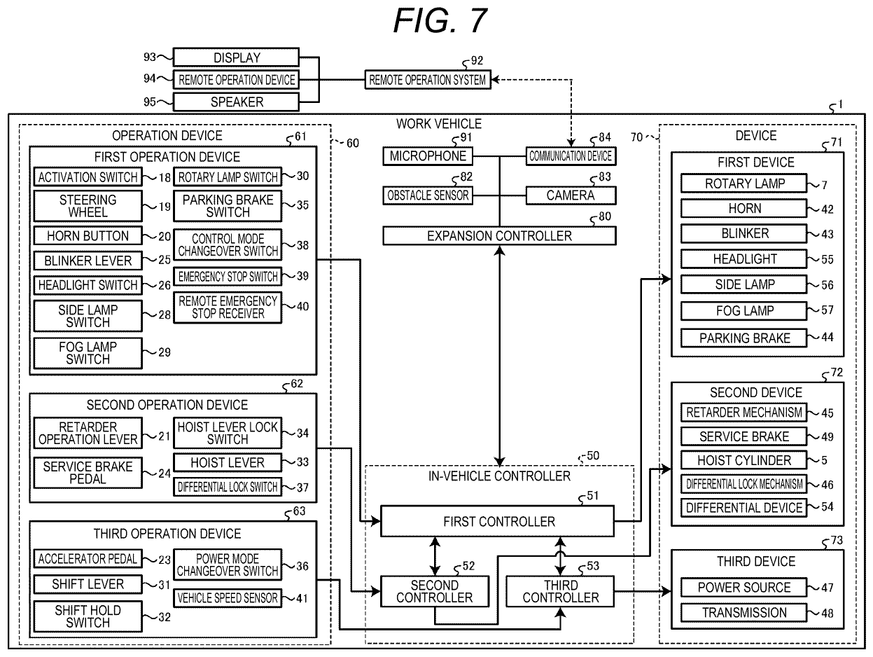

In the above-described embodiment, the work vehicle 1 may be remotely operated. FIG. 7 is a block diagram illustrating a control system for a work vehicle 1 according to an embodiment. In FIG. 7, the work vehicle 1 includes a camera 83 that captures an image of a work site and a microphone 91 that collects sounds at the work site. A communication device 84 communicates with a remote operation system 92. The remote operation system 92 is disposed at a remote place of the work vehicle 1. A display 93, a remote operation device 94, and a speaker 95 are connected to the remote operation system 92. An operator operates the remote operation device 94 at the remote place of the work vehicle 1. An operation signal generated by operating the remote operation device 94 is transmitted to an expansion controller 80 via the remote operation system 92 and the communication device 84. An in-vehicle controller 50 controls the work vehicle 1 on the basis of the operation signal received by the expansion controller 80. Image data of the work site captured by the camera 83 and sound data of the work site collected by the microphone 91 are transmitted to the remote operation system 92 via the communication device 84. The image data of the work site is displayed on the display 93. The sound data of the work site is output from the speaker 95. The operator can operate the remote operation device 94 while checking the image data of the work site and the sound data of the work site.

### Reference Signs List

1 Work vehicle
2 Vehicle rear part
3 Vehicle front part
5 Hoist cylinder
6 Dump body
7 Rotary lamp
10 Front frame
11 Rear frame
12 Front wheel
13 Rear wheel
13f Rear front wheel
13r Rear rear wheel
16 Cab
18 Activation switch
19 Steering wheel
20 Horn button
21 Retarder operation lever
23 Accelerator pedal
24 Service brake pedal
25 Blinker lever
26 Headlight switch
28 Side lamp switch
29 Fog lamp switch
30 Rotary lamp switch
31 Shift lever
32 Shift hold switch
33 Hoist lever
34 Hoist lever lock switch
35 Parking brake switch
36 Power mode changeover switch
37 Differential lock switch
38 Control mode changeover switch
39 Emergency stop switch
40 Remote emergency stop signal receiver
41 Vehicle speed sensor
42 Horn
43 Blinker
44 Parking brake
45 Retarder mechanism
46 Differential lock mechanism
47 Power source
48 Transmission
49 Service brake
50 In-vehicle controller
51 First controller
52 Second controller
53 Third controller
54 Differential device
55 Headlight
56 Side lamp
57 Fog lamp
60 Operation device
61 First operation device
62 Second operation device
63 Third operation device
70 Device
71 First device
72 Second device
73 Third device
80 Expansion controller
81 Position sensor
82 Obstacle sensor
83 Camera
84 Communication device
90 Unmanned travel control system
91 Microphone
92 Remote operation system
93 Display
94 Remote operation device
95 Speaker
1000 Computer system
1001 Processor
1002 Main memory
1003 Storage
1004 Interface

1. A control system for a work vehicle capable of switching between a manned operation state and an unmanned control state, the control system comprising:
an in-vehicle controller; and
a retarder mechanism that generates a braking force for decelerating the work vehicle, wherein
the in-vehicle controller switches from the manned operation state to the unmanned control state in a state where the retarder mechanism is in an operative state.

2. The control system for a work vehicle according to claim 1, further comprising:
a first operation device operated to operate the retarder mechanism, wherein
the in-vehicle controller determines whether or not the retarder mechanism is in an operative state on a basis of an operation state of the first operation device.

3. The control system for a work vehicle according to claim 1, further comprising:
a parking brake that maintains a stopped state of the work vehicle, wherein
the in-vehicle controller switches from the manned operation state to the unmanned control state in a state where the parking brake is engaged.

4. The control system for a work vehicle according to claim 1, further comprising:
an expansion controller that outputs a control command for controlling the work vehicle in the unmanned control state, wherein
the in-vehicle controller switches from the manned operation state to the unmanned control state in a state where a control command for differentiating the retarder mechanism is output from the expansion controller.

5. The control system for a work vehicle according to claim 1, further comprising:
a first operation device operated to operate the retarder mechanism, wherein
the in-vehicle controller monitors that the first operation device is in an operation state of operating the retarder mechanism in the unmanned control state.

6. The control system for a work vehicle according to claim 5, wherein
the work vehicle is stopped in accordance with the operation state of the first operation device in a case where the unmanned control state is switched to the manned operation state.

7. The control system for a work vehicle according to claim 1, further comprising:
a plurality of operation devices that operates the work vehicle, wherein
the in-vehicle controller stops the work vehicle in a case where at least one of the plurality of operation devices is operated in the unmanned control state.

8. The control system for a work vehicle according to claim 7, wherein
the in-vehicle controller stops the work vehicle under a first vehicle stop condition in a case where at least one of the operation devices is operated and an error signal related to the retarder mechanism is not received in the unmanned control state, and
the in-vehicle controller stops the work vehicle under a second vehicle stop condition in a case where at least one of the operation devices is operated and an error signal related to the retarder mechanism is received in the unmanned control state.

9. A control method for a work vehicle capable of switching between a manned operation state and an unmanned control state, the control method comprising:
monitoring an operation state of a first operation device that is operated to operate a retarder mechanism that brakes the work vehicle; and
switching from the manned operation state to the unmanned control state in a state where the first operation device is operated so that the retarder mechanism operates.
